(19) United States
(12) Patent Application Publication
(10) Pub. No.: US 2007/0129922 A1
(43) Pub. Date: Jun. 7, 2007

(54) Satellite simulation system using component-based satellite modeling

(75) Inventors: Sang-Uk Lee, Daejon (KR); Ok-Chul Jung, Jeonbuk (KR); Seong-Kyun Jeong, Gwangju (KR); Jae-Hoon Kim, Daejon (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/437,612

(22) Filed: May 22, 2006

(30) Foreign Application Priority Data
Dec. 1, 2005 (KR) 10-2005-0116048
Apr. 10, 2006 (KR) 10-2006-0032491

(51) Int. Cl. G06F 17/50

(52) U.S. Cl. 703/13

(57) ABSTRACT

Provided is a satellite simulation system based on component-based satellite modeling. The system includes: a user interface unit for receiving simulation control commands and data and parameter required for simulation from a user; a satellite model unit for individually storing information dependant on the satellite, characteristics of the simulation object model and parameter information based on the characteristics, and performing simulation upon receipt of simulation control commands; and a simulation kernel unit for creating a schedule control command for simulation control of the satellite model unit, the onboard simulation unit and the external interface unit by the control command receiving/transmitting from/to the control command/telemetry to satellite control system, performing control and collecting and managing simulation results.

### FIELD OF THE INVENTION

The present invention relates to a satellite simulation system by component-based satellite modeling; and, more particularly, to a satellite simulation system which forms a component-based model by separating data dependent on each satellite and characteristics of a modeling object, and running the model and performs simulation by scheduling and managing processes of component elements.

### DESCRIPTION OF RELATED ART

All the countries in the world are developing various communication systems in an effort to establish highly advanced information oriented society and accelerates to do so. As part of the efforts, countries are developing various satellites including a multi-purpose LEO(Low Earth Orbit) satellite. A satellite simulation system plays a very important role to efficiently perform the above-mentioned satellite based communications service system.

Generally, the satellite simulation system including mechanical device of various characteristics simulates dynamics of a satellite in a three dimensional space and simulates the operation of the satellite. That is, the satellite simulation system simulates a function as a virtual satellite to verify a satellite control system in a developmental phase of the satellite, a function applied to an operator training of a satellite operator and a satellite operation rehearsal in a phase before the satellite is launched, and a function of verifying telecommands to be transmitted to the satellite and analyzing an abnormalies of the satellite in an operation phase of the satellite.

Meanwhile, the satellite simulation system requires various modeling for a space environment model showing a space environment where the satellite is to be operated performed, a flight dynamics model showing a satellite attitude and orbital motion, and a hardware unit model including sensors, actuators, and signal transmitting/receiving devices.

A conventional satellite simulation system is highly expensive and risky since a new simulation model should be developed to perform simulation whenever a satellite is developed. Also, it is emphasized to reuse a simulation model by using an object-oriented design technique in that of satellites, which is a simulation object, are manufactured by a similar module.

The satellite simulation method based on the object-oriented design technique is to extract common features between simulation models, introduce an abstract model including all of the common features and form an inherited model as a specific simulation system inherits characteristics from the abstract model.

Since the conventional method realizes a model by introducing a plurality of abstract models of similar characteristics or introducing a second abstract model inherited from a first abstract model, there is a problem that modeling is performed through multiple phases of inheritance. That is, in the conventional method, which is a top-down method, an inherited model is formed after the abstract model is formed. Accordingly, when the inherited model has different characteristics from those of the abstract model, another abstract model should be formed. Also, it is not possible to form a generalized abstract model, which can include all various models in the conventional method.

Meanwhile, a model should be designed by using a component-based model design technique to be applied to the development of a satellite simulation system in the conventional method. The component-based model design method makes it possible to develop components-jointed software and forms an entire satellite simulation system based on pre-defined component models.

To taken an example of the conventional component-based model design method, a Simulation Model Portability (SMP) standard, which is drawn up and distributed by the European Space Agency (ESA), defines various forms of models in a catalog file, forms a specific model in consideration of interface and inheritability and connects model instances through an assembly file. Also, in the SMP standard, various information is exchanged between element models or between a model and a simulation environment through interfaces.

However, there is a problem that the SMP standard requires a process for mapping the defined model in a specific programming language for actual simulation, and forming a core part as characteristics of each model or a core part such as algorithm.

### SUMMARY OF THE INVENTION

It is, therefore, an object of the present invention to provide a satellite simulation system that can form a component-based model by separating data dependant on each satellite and characteristics of a modeling object, and to perform simulation by running the model and scheduling and managing of a process of constituent elements.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

In accordance with one aspect of the present invention, there is provided a satellite simulation system using component-based satellite modeling including an external interface for transmitting telecommand from and receiving telemetry to a satellite control system and an onboard simulation unit simulating a flight software function for controlling a satellite in an onboard computer of the satellite, the system including: a user interface unit for receiving simulation control command, and data and parameter required for simulation from a user; a satellite model unit for individually storing information dependant on the satellite, which is a simulation object, characteristics of the simulation object model and parameter information based on the characteristics, and performing simulation upon receipt of simulation control commands; and a simulation kernel unit for creating a schedule control command for simulation control of the satellite model unit, the onboard simulation unit and the external interface unit by the control command receiving/transmitting from/to the control command/telemetry to satellite control system, performing control and collecting and managing simulation results.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a top-level structure of satellite simulation system in accordance with an embodiment of the present invention;

FIG. 2 is a block diagram showing a generic view component-based satellite modeling structure in accordance with an embodiment of the present invention;

FIG. 3. is a block diagram showing a sensor model as an hardware unit example based on a component-based modeling in accordance with an embodiment of the present invention; and

FIG. 4 is a block diagram showing an orbit dynamics model as dynamics model example based on the component-based modeling in accordance with another embodiment of the present invention is applied.

### DETAILED DESCRIPTION OF THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

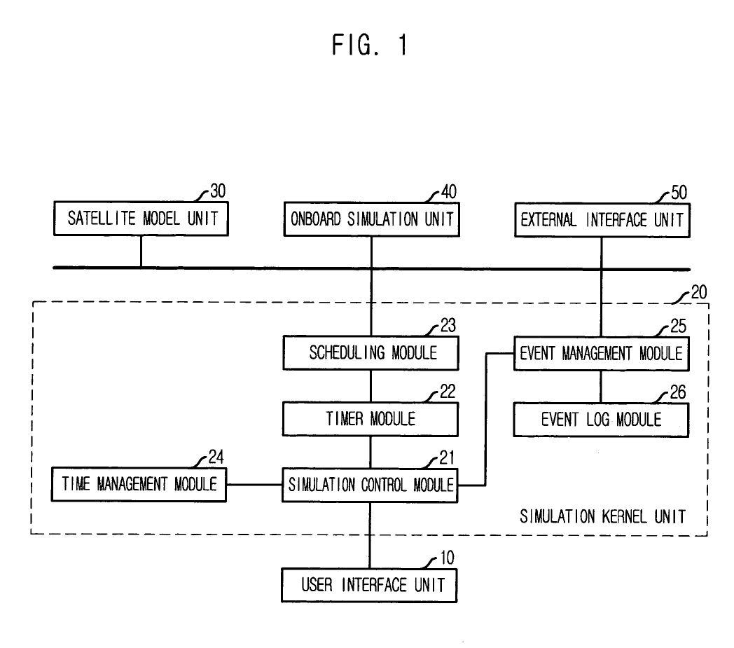

FIG. 1 is a block diagram showing a satellite simulation system based on component-based satellite modeling in accordance with an embodiment of the present invention.

As shown in FIG. 1, the satellite simulation system of the present invention includes a user interface unit 10, a simulation kernel unit 20, a satellite model unit 30, an onboard simulation unit 40 and an external interface unit 50.

The user interface unit 10 receives control commands from an operator of a satellite simulation system, i.e., a user, such that simulation can be entirely performed and controlled. Accordingly, the user interface unit 10 provides various control commands inputted by the user to the simulation kernel unit 20. In particular, the user interface unit 10 receives data required for simulation of the satellite simulation system and parameters associated with the simulation.

The simulation kernel unit 20 processes a control command inputted from the user interface unit 10 and manages the entire simulation. That is, the simulation kernel unit 20 processes the inputted control command and manages the satellite model unit 30, the onboard simulation unit 40 and the external interface unit 50.

It will be described in detail hereinafter.

The simulation kernel unit 20 executes a satellite model process of the satellite model unit 30, the onboard simulation unit 40 and the external interface unit 50 through scheduling control. Also, the simulation kernel unit 20 collects and manages various events generated as a result of the above process.

The simulation kernel unit 20 includes a simulation control module 21, a timer module 22, a scheduling module 23, a time management module 24, an event management module 25 and an event log module 26 to perform the above-mentioned functions.

The simulation control module 21 transmits a control command to be transmitted to a processor of the satellite model unit 30, the onboard simulation unit 40 and the external interface unit 50 to the timer module 22.

The timer module 22 generates a time tick corresponding to the control command transmitted from the simulation control module 21 and transmits the time tick to the scheduling module 23.

The scheduling module 23 controls an operation schedule of satellite model processors of the satellite model unit 30, the onboard simulation unit 40 and the external interface unit 50 based on the time tick transmitted from the timer module 22.

Meanwhile, the simulation control module 21 receives system time and simulation time of a computer from the time management module 24. Herein, the simulation control module 21 synchronizes the transmitted system time with simulation time of the computer and performs the simulation.

The simulation control module 21 generates time tick once through the timer module 22 in the simulation initialization step. Herein, the schedule module 23 performs a satellite model process of the satellite model unit 30, the onboard simulation unit 40 and the external interface unit 50 by one time tick generated from the timer module 22 upon request of the simulation control module 21. Subsequently, the schedule module 23 initializes the simulation. Accordingly, the satellite model unit 30 makes it possible to perform simulation based on the structure of the satellite by setting up satellite-dependant information, which will be described hereinafter.

Additionally, when the simulation is initialized, the simulation control module 21 performs simulation in real-time by initializing various parameters and synchronizing the simulation time with the computer system time.

When the simulation is initialized based on a simulation schedule, the simulation control module 21 consistently generates time tick through the timer module 22 in the initial step of the simulation and starts simulation.

The simulation control module 21 controls the process speed of simulation by changing a generation period of the time tick on the basis of time unit of the timer module 22. That is, the simulation control module 21 requests the timer module 22 to shorten the generation period of the time tick per unit time in order to perform the simulation faster than real-time, or it requests the timer module 22 to extend the generation period of the time tick per unit time in order to perform the simulation slower than real-time.

The simulation control module 21 stops the generation of the time tick through the timer module 22 to temporarily halt the simulation. Subsequently, the simulation control module 21 continuously generates the time tick through the timer module 22 to resume the temporarily halted simulation.

The simulation control module 21 ends the simulation by stopping the time tick generation in the timer module 22. Herein, the timer module 22 has the scheduling module 23 transmit an end command to the processes of the satellite model unit 30, the onboard simulation unit 40 and the external interface unit 50.

The timer module 22 receives a control command from the simulation control module 21, generates time tick in response to the control command and transmits the time tick to the scheduling module 23. Herein, the timer module 22 updates simulation time by transmitting information on the time tick generation to the time management module 24.

The scheduling module 23 receives the time tick corresponding to the control command from the timer module 22, calls a simulation schedule planned during the scheduling and transmits an execution command to the satellite model unit 30, the onboard simulation unit 40 and the external interface unit 50.

The time management module 24 manages system time and simulation time of a computer. In particular, the time management module 24 manages the simulation time based on the time tick of the timer module 22. Also, the time management module 24 provides the system time and the simulation time of the computer to the simulation control module 21. The time management module 24 transforms the simulation time to global positioning system (GPS) constellation time, Greenwich Mean Time (GMT), Korea Standard Time (KST), or GPS time one from another.

The event management module 25 collects and manages all events generated from the processes of the satellite model unit 30, the onboard simulation unit 40 and the external interface unit 50 based on significance. Also, the event management module 25 transmits the collected event information to the simulation control module 21 and the event log module 26.

The event log module 26 stores the events transmitted from the event management module 25. Herein, the event log module 26 provides the event information to the user. For example, the event information is displayed on a screen and outputted to a printer.

The satellite model unit 30, the onboard simulation unit 40 and the external interface unit 50 will be described hereinafter.

The satellite model unit 30 includes a hardware unit model of the satellite, a flight dynamics model including an orbit and posture dynamics model of the satellite, and a space environment model modeling a space environment performed by the satellite. In particular, the satellite model unit 30 performs simulation by forming a closed loop with the onboard simulation unit 40.

The onboard simulation unit 40 is loaded in an onboard computer of the satellite and simulates a function of flight software for controlling the satellite. Herein, the onboard simulation unit 40 performs cross compile on the flight software, or performs the simulation by loading the flight software in an execution file on a process emulator.

The external interface unit 50 provides interface with a satellite control system to make the user operate the satellite. In particular, the external interface unit 50 makes the simulation kernel unit 20 receive telecommands from the satellite control system and periodically transmit telemetry.

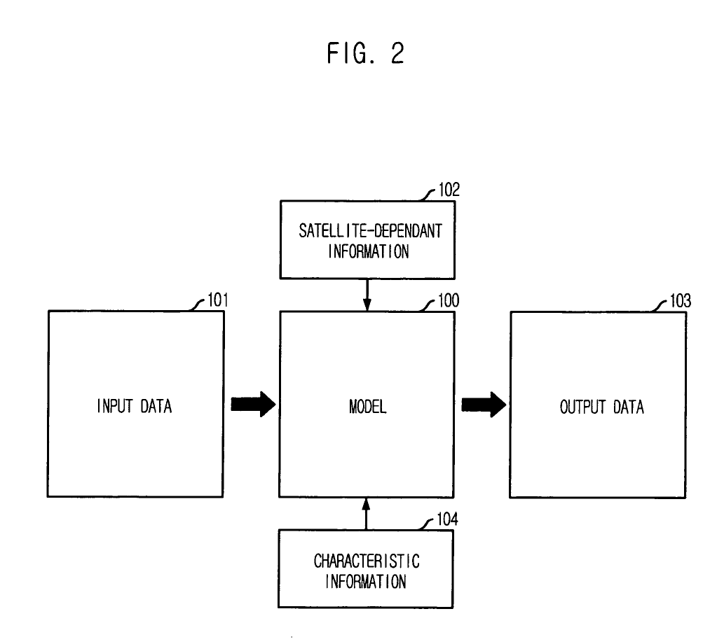

FIG. 2 is a block diagram showing a component-based satellite modeling structure in accordance with an embodiment of the present invention.

As shown in FIG. 2, the component-based satellite modeling structure of the present invention includes a model 100, input data 101, satellite-dependant information 102, output data 103 and characteristic information 104 of a modeling object. The component-based satellite modeling structure can be realized by the satellite model unit 30 and a component-based model is formed by separating satellite-dependant information and characteristic information.

The satellite modeling structure of the present invention will be described in detail hereinafter.

The model 100 is an algorithm of the simulation model and it uses input/output data 101 and 103, the satellite-dependant information 102, and the characteristic information 104.

The satellite-dependant information 102 indicates how the model of the modeling object is connected to a simulation object, i.e., satellite. The satellite-dependant information 102 can be modified such that the model can be recycled for another satellite.

The characteristic information 104 sets up characteristics of the model to be modeled or parameters based on the characteristics.

In the satellite modeling structure, it is preferable to form a model specification including a model name, model description, a model category, an author and modification such that other users can easily access to the model.

Meanwhile, the satellite model unit 30 receives a control command on simulation initialization from the simulation kernel unit 20. Subsequently, the satellite model unit 30 creates a satellite modeling structure by setting up the model 100, the satellite-dependant information 102 and the characteristic information 104.

When simulation is performed based on a simulation schedule, the satellite model unit 30 receives the input data 101 and performs simulation of the model. Subsequently, the satellite model unit 30 provides the output data 103 of the model, which are event information generated from the simulation, to the simulation kernel unit 20.

The satellite model unit 30 ends the simulation of the model according to an end command of the simulation schedule transmitted from the simulation kernel unit 20.

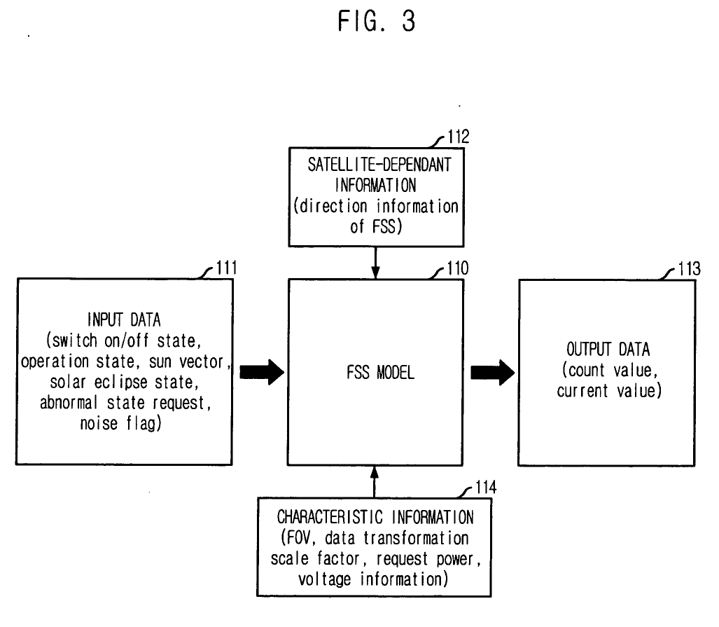

FIG. 3 is a block diagram showing a component-based modeling in accordance with an embodiment of the present invention.

As shown in FIG. 3, the component-based model of the present invention, which is an example of a model related to hardware units of the satellite, is a Fine Sun Sensor (FSS) model 110 of a satellite.

The FSS model 110 receives a switch on/off state of the FSS, an operation state of the FSS, a sun vector in a satellite body coordinate system, a solar eclipse state, abnormal state request and a noise flag as an input data 111 and outputs a count value and a current value of the FSS model as the output data 113 based on an algorithm in the inside of the FSS model 110.

The FSS model 110 should have characteristic information 114, which are data showing characteristics of only the FSS, such as field of view (FOV), data transformation scale factor, requested power and voltage information.

Since every satellite has the FSS mounted therein in a different operation direction, the FSS model 110 is formed on a component basis to be able to set up satellite-dependant information 112 including FSS orientation, i.e., direction cosine matrix, in the outside.

Accordingly, the FSS model 110 is realized with the above hardware unit model components according to its own characteristics. The FSS model 110 can be applied to simulation of another satellite.

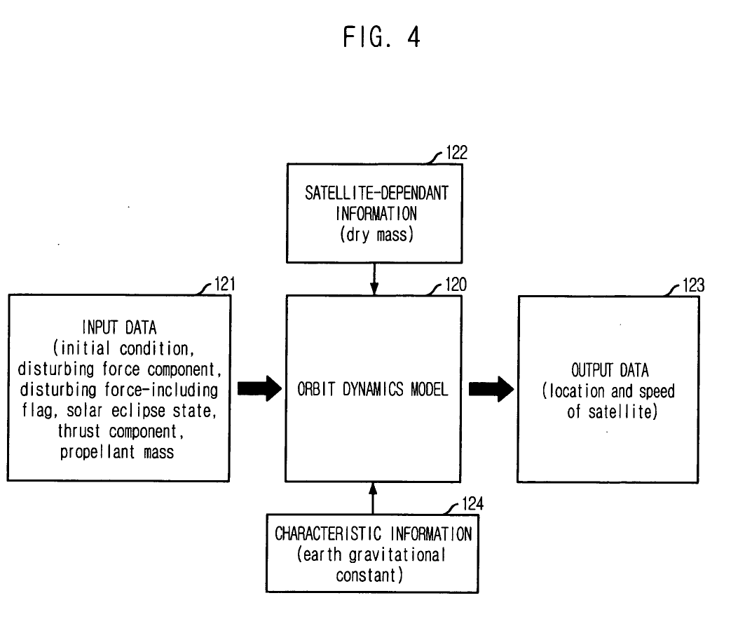

FIG. 4 is a block diagram showing the component-based modeling in accordance with another embodiment of the present invention is applied.

As shown in FIG. 4, the component-based model of the present invention is an orbit dynamics model 120 of the satellite, which is an example of a flight dynamics model such as a satellite orbit and posture dynamics model.

The orbit dynamics model 120 is expressed in the form of a differential equation based on Newton' Laws of Motion and the Laws of Gravitation. The orbit dynamics model 120 includes a disturbing force component such as earth non-zonal geopotential, atmosphere drag, gravitation of the sun and the moon and solar radiation pressure, and a thrust component by usage of a satellite body thruster.

That is, the orbit dynamics model 120 receives an initial conditions indicating location, speed or orbital element of the satellite, disturbing force component, disturbing force-including flag, which can be different according to selection of the user, a solar eclipse state, a thrust component and a propellant mass as the input data 121. Then, the orbit dynamics model 120 outputs location and speed of the satellite as the output data 123 according to an algorithm in the inside of the orbit dynamics model 120.

The orbit dynamics model 120 should have parameters required based on the characteristics of an orbit to be simulated, i.e., the characteristic information 124. Herein, the orbit dynamics model 120 has earth gravitational constant as the characteristic information 124. This shows that the orbit dynamics model 120 is a model for an object calculating an orbit moving around earth.

Since dry mass differs according to the type or operation period of the satellite, the orbit dynamics model 120 manages the dry mass as satellite-dependant information 122 and forms the component-based orbit dynamics model which can be set up in the outside.

The orbit dynamics model 120 is formed by using the part for flight dynamics model including the above mentioned orbit and posture dynamics model as its component, and the orbit dynamics model 120 can be applied to the simulation of another satellite.

The present invention can apply a verified hardware component such as an actual hardware unit to a simulation device of a new satellite. Also, the present invention can be easily extended and applied although a simulation object satellite is changed.

As described in detail, the technology of the present invention can be realized as a program and stored in a computer-readable recording medium, such as CD-ROM, RAM, ROM, a floppy disk, a hard disk and a magneto-optical disk. Since the process can be easily implemented by those skilled in the art of the present invention, further description will not be provided herein.

The present application contains subject matter related to Korean patent application Nos. 2005-0116048 and 2006-0032491 filed with the Korean Intellectual Property Office on Dec. 1, 2005, and Apr. 10, 2006, respectively, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A satellite simulation system using component-based satellite modeling including an external interface unit for receiving/transmitting telecommands and telemetry from/to a satellite control system and an onboard simulation unit simulating a flight software function for controlling a satellite in an onboard computer of the satellite, comprising:
a user interface unit for receiving simulation control commands and data and parameter required for simulation from a user;
a satellite model unit for individually storing information dependant on the satellite, which is a simulation object, characteristics of the simulation object model and parameter information based on the characteristic, and performing simulation upon receipt of simulation control commands; and
a simulation kernel unit for creating a schedule control command for simulation control of the satellite model unit, the onboard simulation unit and the external interface unit by receiving/transmitting from/to the control command/telemetry to satellite control system, performing control and collecting and managing simulation results.

2. The system as recited in claim 1, wherein the simulation kernel includes:
a time management module for managing simulation time and system time of the onboard computer;
a simulation control module for receiving the simulation time and the system time of the computer from the time management module, and activating control commands for executing the simulation according to time when the control commands are inputted through the user interface unit;
a timer module for generating time tick corresponding to each control command transmitted from the simulation control module, and transmitting information on generation of the time tick to the time management module;
a scheduling module for transmitting a command controlling a simulation schedule based on the time tick transmitted from the timer module to the satellite model unit, the onboard simulation unit and the external interface unit;
an event management module for collecting and managing event information on output data transmitted from the satellite model unit, the onboard simulation unit and the external interface unit; and
an event log module for storing the event information.

3. The system as recited in claim 2, wherein the simulation control module controls process speed of the simulation by adjusting a time tick generation period of the timer module.

4. The system as recited in claim 2, wherein the simulation control module halts the operation of the simulation by stopping the generation of time tick in the timer module, and continues to generate the time tick to resume the halted simulation.

5. The system as recited in claim 1, wherein the satellite model unit performs the simulation by forming a closed loop with the onboard simulation unit.

6. The system as recited in claim 1, wherein satellite-dependant information of the satellite model unit can be modified by the user.

7. The system as recited in claim 1, wherein the satellite model unit forms a satellite modeling structure by receiving a control command for simulation initialization from the simulation kernel, and setting up the simulation object model, and the satellite-dependant information, the characteristic information.

8. The system as recited in claim 1, wherein the satellite model unit ends the simulation of the model according to an end command of the simulation schedule transmitted from the simulation kernel unit.
